(19) United States
(12) Patent Application Publication
(10) Pub. No.: US 2025/0319696 A1
(43) Pub. Date: Oct. 16, 2025

(54) LIQUID DISCHARGE HEAD

(71) Applicant: CANON KABUSHIKI KAISHA, Tokyo (JP)

(72) Inventors: ISAMU YONEDA, Kanagawa (JP); SHUHEI OYA, Kanagawa (JP)

(21) Appl. No.: 19/170,493

(22) Filed: Apr. 4, 2025

(30) Foreign Application Priority Data
Apr. 10, 2024 (JP) 2024-063128

(51) Int. Cl. B41J 2/14

(52) U.S. Cl. CPC B41J 2/14; B41J 2202/12

(57) ABSTRACT

A liquid discharge head includes a substrate including at least one liquid supply path for supplying liquid, a flow path forming member including a plurality of discharge ports for discharging the liquid, joined with the substrate, and configured to form a flow path communicating with the plurality of discharge ports and the at least one liquid supply path, and at least one discharge hole for discharging the liquid, provided in an area facing the at least one liquid supply path of the flow path forming member to penetrate through the flow path forming member.

### BACKGROUND

### Field

The present disclosure relates to a liquid discharge head.

### Description of the Related Art

In a liquid discharge head that discharges liquid, when foreign matters enter a flow path communicating with a discharge port, the discharge port may be clogged with the foreign matters, and discharge defects of the liquid may occur.

Japanese Patent Application Laid-open No. 2006-231742 discusses an ink jet recording apparatus that can reduce the discharge defects caused by the clogging of the discharge port. Such an ink jet recording apparatus has a group of discharge ports each having a small opening area (hereinbelow, referred to as a small-opening discharge port group), and a group of discharge ports each having a large opening area (hereinbelow, referred to as a large-opening discharge port group). The large-opening discharge port group is arranged at end portions in an arranging direction of the small-opening discharge port group. Large-opening discharge ports are dummy discharge ports that do not contribute to recording. Foreign matters that have entered a flow path can be discharged by suctioning liquid via the large-opening discharge ports.

In the ink jet recording apparatus discussed in Japanese Patent Application Laid-open No. 2006-231742, a large-opening discharge port group having a large opening area is disposed at one end portion and the other end portion of the small-opening discharge port group, and therefore there is an issue that the liquid discharge head becomes large by a space required for disposing the large-opening discharge port groups.

### SUMMARY

The present disclosure is directed to a liquid discharge head capable of preventing clogging of discharge ports due to foreign matters while preventing the liquid discharge head from becoming large.

According to some embodiments, a liquid discharge head includes a substrate including at least one liquid supply path for supplying liquid, a flow path forming member including a plurality of discharge ports for discharging the liquid, joined with the substrate, and configured to form a flow path communicating with the plurality of discharge ports and the at least one liquid supply path, and at least one discharge hole for discharging the liquid, provided in an area facing the at least one liquid supply path of the flow path forming member to penetrate through the flow path forming member.

According to another exemplary aspect, a liquid discharge head includes a substrate including at least one liquid supply path for supplying liquid, a flow path forming member including a plurality of discharge ports for discharging the liquid, joined with the substrate, and configured to form a flow path communicating with the plurality of the discharge ports and the at least one liquid supply path, and at least one discharge hole for discharging the liquid, provided in an area adjacent to a discharge port side of an area facing the at least one liquid supply path of the flow path forming member to penetrate through the flow path forming member.

According to still another exemplary aspect, a liquid discharge head includes a discharge port row in which a plurality of discharge ports for discharging liquid is arranged, at least one discharge hole for discharging the liquid, arranged on a lateral side of the discharge port row, a flow path configured to communicate with each of the plurality of discharge ports in the discharge port row, and the at least one discharge hole, and a plurality of energy generation elements configured to generate a discharge energy to discharge liquid. The plurality of energy generation elements faces only the plurality of discharge ports in a discharge direction of the liquid.

Further features of the present disclosure will become apparent from the following description of exemplary embodiments with reference to the attached drawings.

### BRIEF DESCRIPTION OF THE DRAWINGS

FIG. 1 illustrates perspective views of a configuration example of a recording head.

FIG. 2 is an exploded perspective view of the recording head illustrated in FIG. 1.

FIGS. 3A and 3B are schematic diagrams illustrating a configuration of a liquid discharge head according to a first exemplary embodiment of the present disclosure.

FIGS. 4A and 4B are diagrams illustrating a configuration of a liquid discharge portion of a recording element substrate illustrated in FIGS. 3A and 3B.

FIGS. 5A and 5B are schematic diagrams each illustrating a configuration of a cap for performing suction recovery.

FIG. 6 is a cross-section diagram illustrating a cross-section structure of a part of the recording element substrate with the cap attached thereto.

FIG. 7 is a schematic diagram illustrating a state where foreign matters are discharged via a discharge hole.

FIG. 8 is a cross-section diagram illustrating a cross-section structure of a part of the recording element substrate with the cap attached thereto.

FIGS. 9A and 9B are diagrams illustrating a configuration of a liquid discharge head according to a first comparative example.

FIGS. 10A and 10B are schematic diagrams illustrating a state where foreign matters move in a liquid discharge portion illustrated in FIGS. 9A and 9B.

FIGS. 11A and 11B are schematic diagrams illustrating a configuration of a liquid discharge head according to a second exemplary embodiment of the present disclosure.

FIGS. 12A and 12B are diagrams illustrating a configuration of a liquid discharge portion of a recording element substrate illustrated in FIGS. 11A and 11B.

FIGS. 13A and 13B are schematic diagrams each illustrating a configuration of a cap for performing suction recovery.

FIG. 14 is a cross-section diagram illustrating a cross-section structure of a part of the recording element substrate with the cap attached thereto.

FIG. 15 is schematic diagram illustrating a state where foreign matters are discharged via discharge holes.

FIG. 16 is a cross-section diagram illustrating a cross-section structure of a part of the recording element substrate with the cap attached thereto.

FIGS. 17A and 17B are diagrams illustrating a configuration of a liquid discharge head according to a second comparative example.

FIGS. 18A and 18B are schematic diagrams illustrating a state where foreign matters move in a liquid discharge portion illustrated in FIGS. 17A and 17B.

FIGS. 19A and 19B are schematic diagrams illustrating a configuration of a liquid discharge head according to a third exemplary embodiment of the present disclosure.

### DESCRIPTION OF THE EMBODIMENTS

Hereinbelow, various exemplary embodiments, features, and aspects of the present disclosure will be described in detail with reference to the attached drawings. The exemplary embodiments are merely examples, and are not intended to limit the range of the present disclosure thereto.

First, a recording head to which a liquid discharge head according to the present disclosure is applicable will be described.

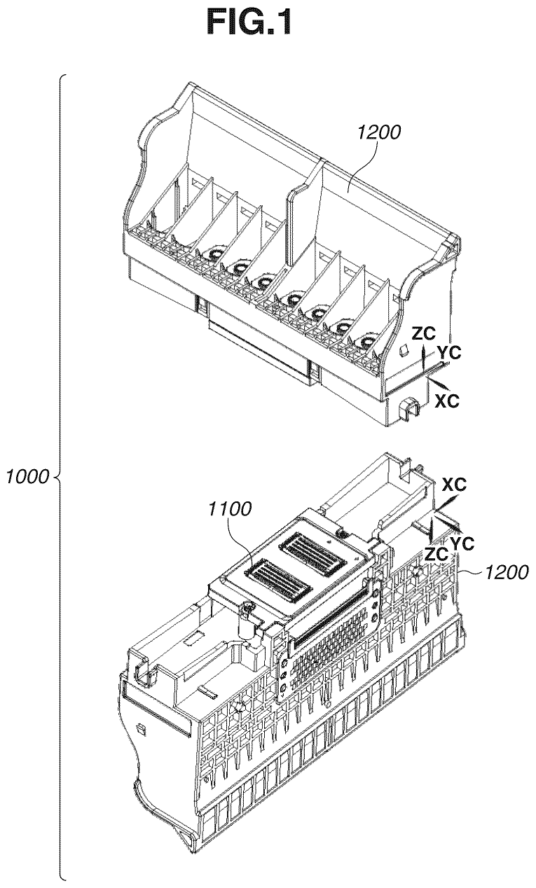

FIG. 1 illustrates perspective views of a configuration example of a recording head. As illustrated in FIG. 1, a recording head 1000 includes a recording element unit 1100 and a tank holder unit 1200 into which the recording element unit 1100 is assembled.

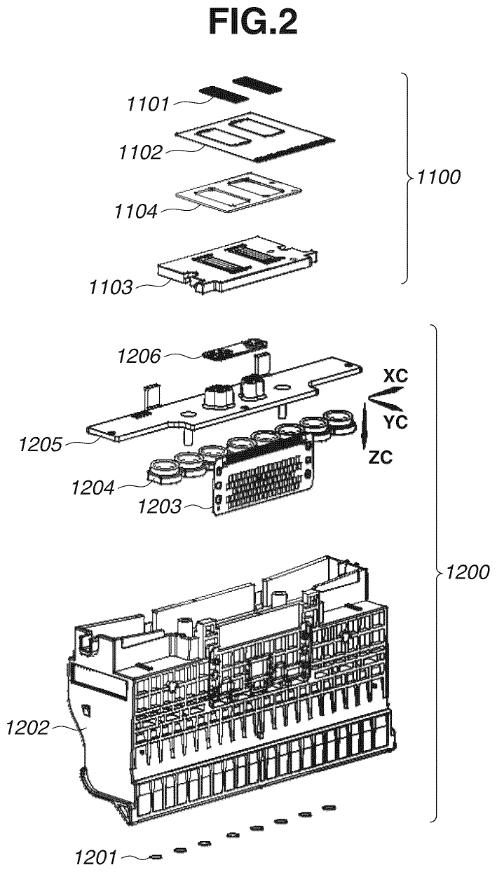

FIG. 2 is an exploded perspective view of the recording head 1000 illustrated in FIG. 1. The recording element unit 1100 includes recording element substrates 1101, an electric wiring member 1102, and support members 1103 and 1104. The recording element substrates 1101 are fixed onto the support member 1103 by adhesive. The electric wiring member 1102 and the support member 1103 are further fixed onto the support member 1103 by adhesive. The electric wiring member 1102 is electrically connected with the recording element substrates 1101 using wire bonding or inner lead bonding.

The tank holder unit 1200 includes filters 1201, a tip tank 1202, an electric contact substrate 1203, individual sealing rubbers 1204, a flow path plate 1205, and a sealing rubber 1206. The flow path plate 1205 is joined with the support member 1103 via the sealing rubber 1206. The tank holder unit 1200 is supplied with liquid from a liquid tank (not illustrated) containing liquid, such as ink, via the filters 1201. The supplied liquid is sent to the flow path plate 1205 via the tip tank 1202 and the individual sealing rubbers 1204, and then supplied to the recording element substrates 1101 via the support member 1103.

In the recording head 1000 described above, the liquid supplied via the filters 1201 contacts various components before reaching the recording element substrates 1101. In a manufacturing process or an assembling process of the recording head 1000, foreign matters come in due to the contact of the liquid with the components. Herein, the foreign matters are, for example, dusts adhering to the components or materials of the components themselves. When the liquid tank is replaced, there is also a possibility that foreign matters may come into the liquid supplied via the filters 1201. The components are washed, and the assembly is performed in a clean room, but it is difficult to completely remove the foreign matters.

The liquid discharge head according to the present disclosure is configured to reduce the clogging of the discharge ports due to foreign matters. Hereinbelow, exemplary embodiments of a liquid discharge head according to the present disclosure will be described in detail.

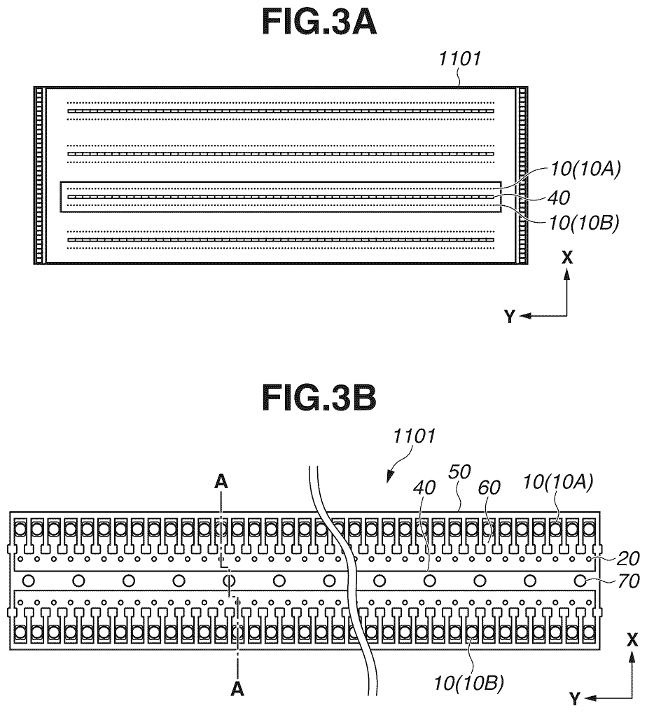

FIGS. 3A and 3B are schematic diagrams illustrating a configuration of a liquid discharge head according to a first exemplary embodiment. FIG. 3A is a top view of the recording element substrate 1101. FIG. 3B is a schematic diagram illustrating a part of a liquid discharge portion of the recording element substrate 1101 illustrated in FIG. 3A viewed from the discharge port side.

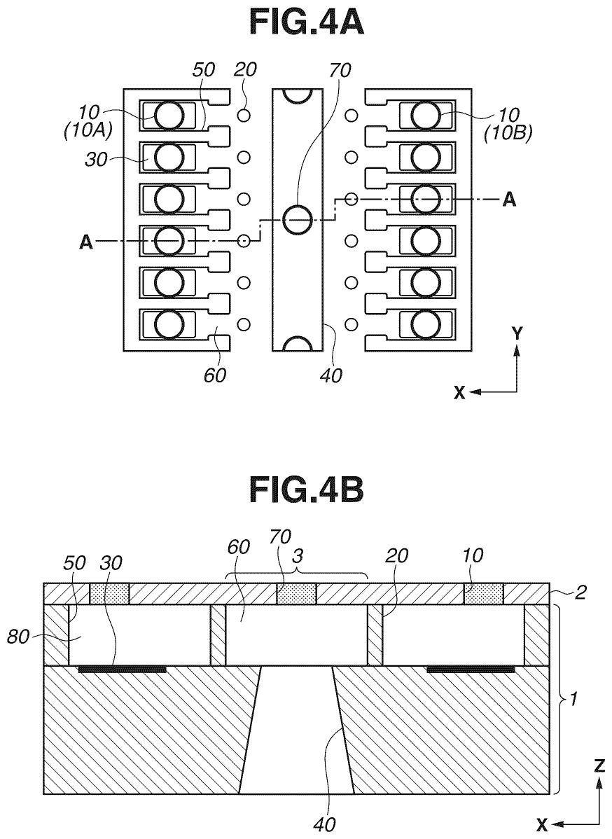

FIGS. 4A and 4B are diagrams illustrating a configuration of the liquid discharge portion of the recording element substrate 1101 illustrated in FIG. 3B. FIG. 4A is an enlarged view illustrating a part of the liquid discharge portion. FIG. 4B is a cross-section diagram of the liquid discharge portion taken along an A-A line illustrated in FIG. 4A.

The liquid discharge head according to the present exemplary embodiment includes the recording element substrate 1101 illustrated in FIGS. 3A, 3B, 4A, and 4B. The recording element substrate 1101 includes a substrate 1 and a flow path forming member 2. The substrate 1 is provided with a liquid supply path 40 for supplying liquid therethrough. The flow path forming member 2 is provided with a plurality of discharge ports 10 for discharging liquid therethrough, joined with the substrate 1, and forms a flow path 60 communicating with the plurality of discharge ports 10 and the liquid supply path 40. An area 3 of the flow path forming member 2 facing the liquid supply path 40 is provided with a plurality of discharge holes 70 for discharging liquid therethrough. Each of the discharge holes 70 is formed so as to penetrate through the flow path forming member 2. In the present exemplary embodiment, the discharge ports 10 and the discharge holes 70 are formed circular in shape.

The plurality of discharge ports 10 respectively communicate with the plurality of pressure chambers 80. Each of the pressure chambers 80 is provided with a heater 30 serving as an energy generation element for generating a discharge energy for discharging ink from each of the discharge ports 10. Each of the pressure chambers 80 constitutes a part of the flow path 60, and the liquid from the liquid supply path 40 is supplied to each of the pressure chambers 80. The heaters 30 respectively face only the discharge ports 10 in a liquid discharge direction (Z direction). The energy generation element is not limited to the heater 30. A piezoelectric element or the like can also be used as the energy generation element.

Between the liquid supply path 40 and each of the pressure chambers 80, a plurality of filter members 20 each composed of a columnar structure body is disposed. Each of the pressure chambers 80 is partitioned by flow path walls 50, and includes an opening (inlet port) for supplying liquid to the liquid supply path 40 side. The filter members 20 are arranged near the inlet port of each of the pressure chambers 80. From among the foreign matters, such as dusts, that have entered the flow path 60, the foreign matters larger than the gaps respectively between the filter members 20 and the flow path walls 50 are caught by the filter members 20.

The plurality of discharge ports 10 includes a first discharge port row 10A and a second discharge port row 10B. Each of the first discharge port row 10A and the second discharge port row 10B is a row constituted by arranging the discharge ports 10 in a row at predetermined intervals in a longer direction (Y direction) of the recording element substrate 1101. The Y direction can also be referred to as a first direction. The liquid supply path 40 extends in the Y direction. The plurality of discharge holes 70 faces the liquid supply path 40 in a Z direction, located at a lateral side of the first discharge port row 10A (second discharge port row 10B), and arranged in the Y direction at predetermined intervals. The Z direction indicates a direction perpendicular to a substrate surface (discharge surface with the discharge ports 10 formed therein) of the recording element substrate 1101. In the present exemplary embodiment, the size of the diameter of each of the discharge ports 10 is, for example, 15 μm (micrometers), and the size of the diameter of each of the discharge holes 70 is, for example, 18 μm. For example, twelve discharge holes 70 are arranged at equal intervals between one end and the other end of one liquid supply path 40 in the Y direction. In addition, it is desirable that the number and positions of the discharge holes 70 for one liquid supply path 40 are appropriately set so as to be able to efficiently discharge foreign matters.

For example, at least one discharge hole 70 can be disposed between the liquid supply path 40 for the flow path 60 and the plurality of discharge ports 10. The discharge ports 10 and the discharge holes 70 are circular in shape, but they can also be other than circular in shape, for example, ellipsoidal. In this case, the diameters of the respective discharge ports 10 and the diameters of the respective discharge holes 70 can each be a diameter of a circle with an equivalent area.

The liquid discharge head according to the present exemplary embodiment discharges foreign matters that have entered the flow path 60 from the liquid supply path 40, by suctioning the liquid via the discharge holes 70. The foreign matters enter the flow path 60 from the liquid supply path 40. Thus, as the distance from the liquid supply path 40 to each of the discharge holes 70 is shorter, the time to be used for discharging via the discharge holes 70 the foreign matters that have entered the flow path 60 can be shorter, and the discharge amount of the liquid along with the discharge of the foreign matters can be reduced. In the present exemplary embodiment, foreign matters can be discharged in a short time, and the discharge amount of the liquid along with the discharge of the foreign matters can be reduced, by providing the discharge holes 70 in the area 3 facing the liquid supply path 40.

The center of each of the discharge holes 70 can be located on the center of the liquid supply path 40 in a width direction (X direction) orthogonal to the Y direction. In this way, it is possible to further reduce the time to be used for discharging the foreign matters, and further reduce the discharge amount of the liquid along with the discharge of the foreign matters. The X direction can also be referred to as a second direction.

In the X direction, the center position between the first discharge port row 10A and the second discharge port row 10B is located directly above the liquid supply path 40. Accordingly, foreign matters can be discharged in a short time, and the discharge amount of the liquid along with the discharge of the foreign matters can be reduced, by also arranging the row of the discharge holes 70 at a midpoint between the first discharge port row 10A and the second discharge port row 10B.

It is desirable that the size of the discharge holes 70 are appropriately set in consideration of the sizes of the foreign matters possible to cause the clogging of the discharge ports 10 from among the foreign matters entering the flow path 60 from the liquid supply path 40.

When the discharge hole 70 is formed large, it is difficult to form a meniscus (curvature surface of liquid formed by interaction with the surface in a hole), and there is a possibility of the liquid leaking via the discharge hole 70. Even if the meniscus can be formed, there is a possibility of the liquid leaking via the discharge hole 70 caused by an impact or the like in a case where an enough liquid holding force cannot be obtained. In addition, as the discharge hole 70 is larger, the discharge amount of the liquid along with the discharge of the foreign matters increases. In consideration of the above, the maximum size of the discharge hole 70 is desirably twice the diameter of the discharge port 10. In other words, it is desirable that the diameter of the discharge hole 70 is equal to or less than twice of the diameter of the discharge port 10.

In contrast, when the size of the discharge hole 70 is small, it is possible to obtain an enough liquid holding force for the meniscus, reduce the discharge amount of the liquid when foreign matters are discharged, and reduce the liquid leaking via the discharge hole 70. However, the sizes of the foreign matters possible to discharge via the discharge hole 70 are small. In consideration of the above, in order to reduce the clogging of the discharge ports 10 while reducing the discharge amount of the liquid along with the discharge of the foreign matters, the minimum size of the diameter of the discharge hole 70 is desirably one third of the diameter of the discharge port 10. Further, in consideration of the discharge amount of the liquid and the sizes of the foreign matters possible to cause the clogging of the discharge ports 10, the filter members 20 are usually designed so as to catch the foreign matters with the sizes of one third or more of the discharge port 10 in diameter. In this case, the discharge hole 70 may be able to discharge at least the foreign matters with the sizes that cannot be caught by the filter members 20. Also from this point, the minimum size of the discharge hole 70 is desirably one third of the diameter of the discharge port 10. In other words, it is desirable that the discharge hole 70 is equal to or greater than one third of the discharge port 10 in diameter.

Next, a suction recovery method of the liquid discharge head according to the present exemplary embodiment will be described. The suction recovery method includes a first suction recovery operation of suctioning the liquid via the discharge holes 70 to discharge the foreign matters, and a second suction recovery operation (usual suction recovery operation) of suctioning the liquid via the discharge ports 10 and filling the liquid in the entire flow path 60.

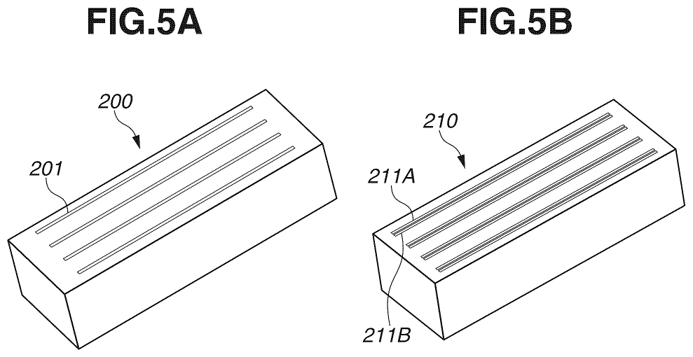

FIGS. 5A and 5B are schematic diagrams each illustrating a configuration of a cap for performing suction recovery. FIG. 5A illustrates a cap used for the first suction recovery operation, and FIG. 5B illustrates a cap used for the second suction recovery operation.

First, the first suction recovery operation will be described.

A cap 200 illustrated in FIG. 5A is attached to the recording element substrate 1101 illustrated in FIG. 3A. The cap 200 is provided with suction holes 201 for each row of the discharge holes 70. In the present exemplary embodiment, since the recording element substrate 1101 has four rows of the discharge holes 70, the cap 200 is provided with four pieces of suction holes 201. However, the number of rows of the suction holes 201 is not limited to four. The number of the suction holes 201 can be appropriately changed depending on the number of rows of the discharge holes 70 or the number of rows of the discharge ports 10.

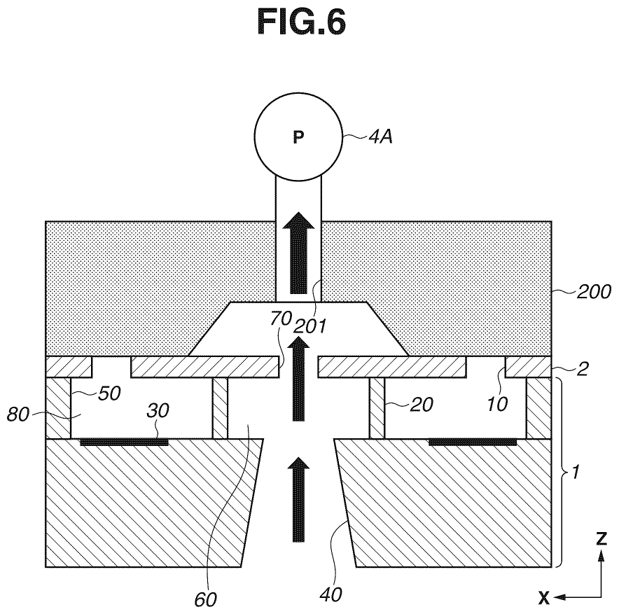

FIG. 6 is a cross-section diagram illustrating a cross-section structure of a part of the recording element substrate 1101 with the cap 200 attached thereto. In FIG. 6, the cross-section part of the recording element substrate 1101 is the same as the cross-section part illustrated in FIG. 4B. Black solid arrows illustrated in FIG. 6 denote flows of liquid.

As illustrated in FIG. 6, the discharge hole 70 communicates with the suction hole 201 of the cap 200, and the discharge ports 10 respectively located on the opposite sides of the discharge hole 70 are both covered by the cap 200. In this state, when the liquid is suctioned via the suction hole 201 using a pump 4A, the liquid is discharged via the liquid supply path 40, the flow path 60, the discharge hole 70, and the suction hole 201.

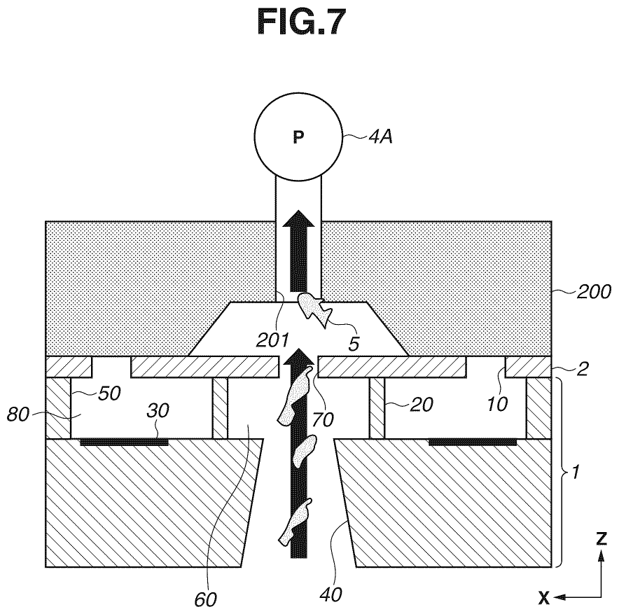

FIG. 7 is a schematic diagram illustrating a state where foreign matters 5 are discharged via the discharge hole 70, in the cross-section diagram illustrated in FIG. 6. Black solid arrows illustrated in FIG. 7 denote flows of liquid. As illustrated in FIG. 7, the foreign matters 5 pass through the liquid supply path 40 and the flow path 60 by the suction operation using the pump 4A, and then is discharged via the discharge hole 70. A foreign matter 5 with a size larger than the diameter of the discharge hole 70 clogs the discharge hole 70, or remains in the flow path 60. The foreign matter 5 with a large size remaining in the flow path 60 can be caught by the filter member 20.

Next, the second suction recovery operation will be described.

A cap 210 illustrated in FIG. 5B is attached to the recording element substrate 1101 illustrated in FIG. 3A. The cap 210 is provided with suction holes (211A and 211B) for respective rows of the discharge ports 10 (10A and 10B). The suction holes (211A and 211B) can each have, for example, an elongated slit shape. In the present exemplary embodiment, since the recording element substrate 1101 is provided with four first discharge port rows 10A and four second discharge port rows 10B, the cap 210 is provided with four suction holes 211A and four suction holes 211B. Each of the first discharge port rows 10A corresponds to each of the suction holes 211A, and each of the second discharge port rows 10B corresponds to each of the suction holes 211B. The number of the suction holes 211A and the number of the suction holes 211B are not limited to four. The number of the suction holes 211A and the number of the suction holes 211B can be appropriately changed depending on the number of rows of the discharge ports 10.

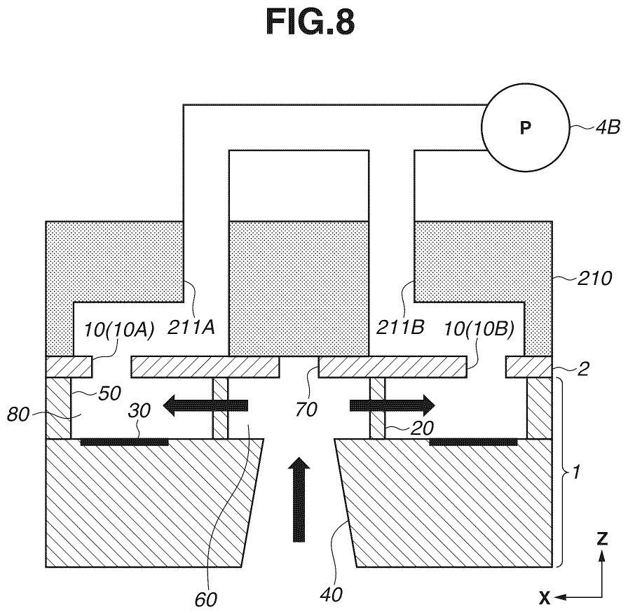

FIG. 8 is a cross-section diagram illustrating a cross-section structure of a part of the recording element substrate 1101 with the cap 210 attached thereto. In FIG. 8, the cross-section part of the recording element substrate 1101 is similar to that illustrated in FIG. 4B. Black solid arrows illustrated in FIG. 8 denote flows of liquid.

As illustrated in FIG. 8, the discharge hole 70 is covered by the cap 210, and the discharge ports 10 (10A and 10B) located on the opposite sides of the discharge hole 70 communicate with suction holes 211A and 211B of the cap 211, respectively. In this state, when the liquid is suctioned via the suction holes 211A and 211B using a pump 4B, the liquid passes through the liquid supply path 40, the flow path 60, the discharge ports 10, and suction holes 211A and 211B, and is discharged. In this way, the liquid can be filled in the entire flow path 60. The pump 4A and the pump 4B can also share one pump.

Next, how a discharge defect caused by the clogging of the discharge ports 10 occurs will be described with reference to a first comparison example of a liquid discharge head not including the discharge holes 70.

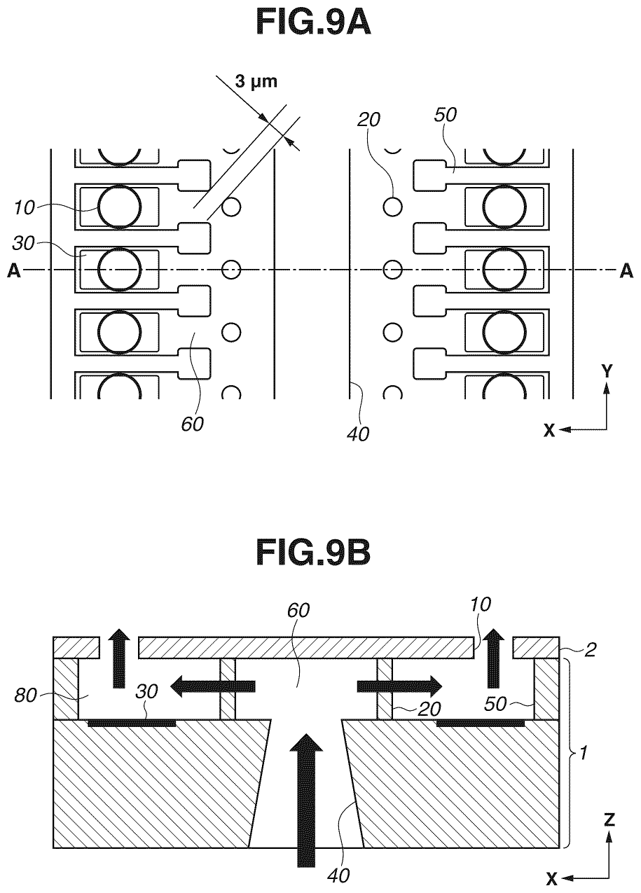

FIGS. 9A and 9B are diagrams illustrating a configuration of a liquid discharge head according to a first comparative example. FIG. 9A is an enlarged view illustrating a part of a liquid discharge portion. FIG. 9B is a cross-section diagram of the liquid discharge portion taken along an A-A line illustrated in FIG. 9A. Black solid arrows illustrated in FIG. 9B denote flows of liquid.

The liquid discharge head according to the first comparison example illustrated in FIGS. 9A and 9B has a same configuration as the liquid discharge portion illustrated in FIGS. 4A and 4B, except in that the liquid discharge head according to the first comparison example does not include the discharge holes 70. The size of a gap between a filter member 20 and a flow path wall 50 is 3 μm.

With the liquid discharge head according to the first comparison example, the suction recovery operation of suctioning the liquid via the discharge ports 10 is performed to fill the liquid in the entire flow path 60, in a manufacturing process and an assembling process and at a time of a liquid tank exchange. As illustrated in FIG. 9B, the liquid passes through the liquid supply path 40 and the flow path 60, and is discharged via the discharge ports 10 through the suction recovery operation. In this way, the liquid can be filled in the entire flow path 60.

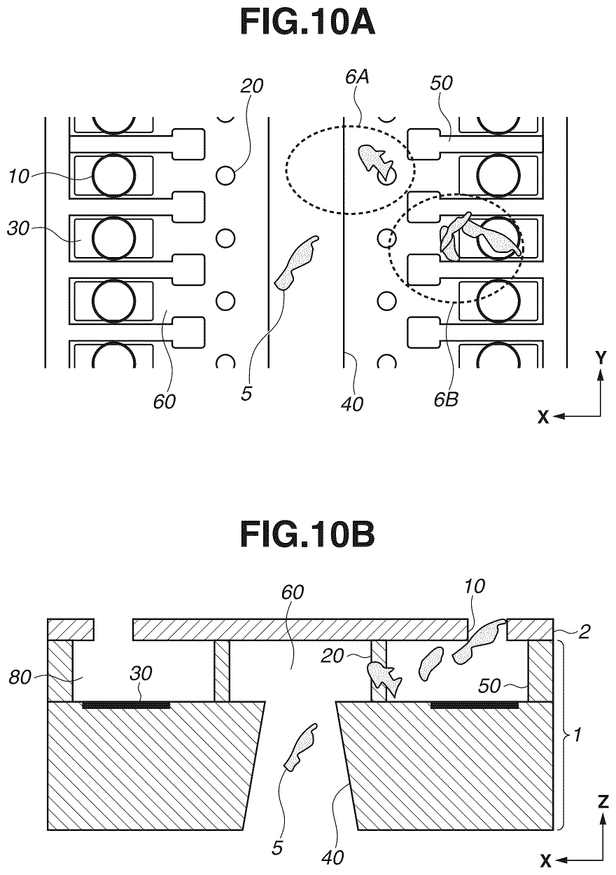

FIGS. 10A and 10B are schematic diagrams illustrating a moving state of foreign matters 5 in FIGS. 9A and 9B. FIG. 10A corresponds to FIG. 9A, and FIG. 10B corresponds to FIG. 9B. As illustrated in FIGS. 10A and 10B, when the suction recovery operation is performed, the foreign matters 5 enter the flow path 60 from the liquid supply path 40, and the foreign matters 5 having passed through the filter member 20 move toward the discharge ports 10. In an area 6A that is outside the pressure chamber 80, the discharge defect does not occur in a state where the foreign matters 5 are caught by the filter members 20. However, in an area 6B that is inside the pressure chamber 80, the clogging of the discharge port 10 caused by the foreign matters 5 occurs, and the discharge defect occurs, accordingly.

For the liquid discharge head according to the present exemplary embodiment, in the manufacturing process and the assembling process and at the time of the liquid tank replacement, the second suction recovery operation is performed after removing foreign matters by performing the first suction recovery operation, to fill the liquid in the entire flow path 60. With this operation, it is possible to prevent the discharge defect caused by the clogging of the discharge ports 10, and as a result, to improve the yield and the print quality.

According to the present exemplary embodiment, the liquid discharge head can achieve the following effects compared with the ink jet recording apparatus discussed in Japanese Patent Application Laid-open No. 2006-231742.

As the liquid discharge heads have become compact in recent years, the recording element substrates are also becoming more compact. In the ink jet recording apparatus discussed in Japanese Patent Application Laid-open No. 2006-231742, since a large-opening discharge port group is disposed on both sides of a small-opening discharge port group, the recording element substrate becomes large by the space for disposing the large-opening discharge port group.

In contrast thereto, in the liquid discharge head according to the present exemplary embodiment, the discharge holes 70 are provided in the area 3 facing the liquid supply path 40, and thus it is possible to prevent the recording element substrate 1101 from becoming large due to the formation of the discharge holes 70.

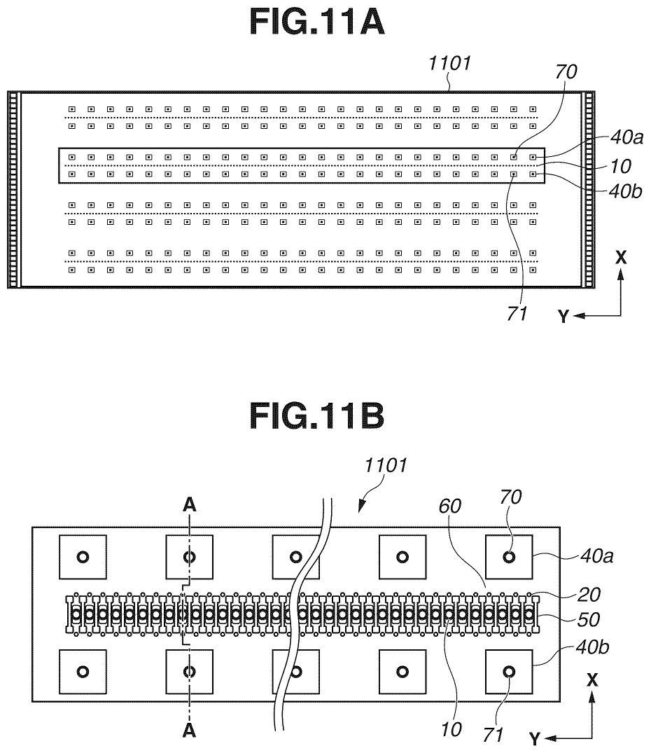

FIGS. 11A and 11B are schematic diagrams illustrating a configuration of a liquid discharge head according to a second exemplary embodiment of the present disclosure. FIG. 11A is a top view of the recording element substrate 1101. FIG. 11B is a schematic diagram illustrating a part of a liquid discharge portion of the recording element substrate 1101 illustrated in FIG. 11A viewed from the discharge port side.

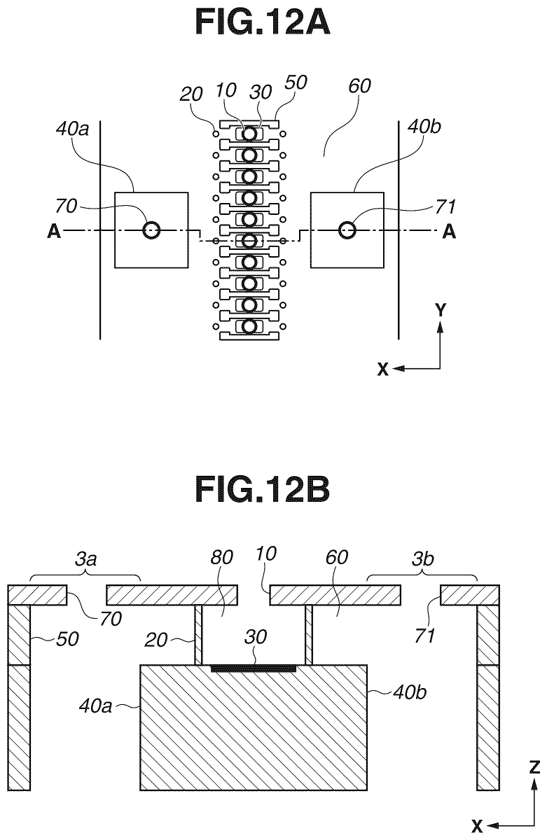

FIGS. 12A and 12B are diagrams illustrating the liquid discharge portion of the recording element substrate 1101 illustrated in FIG. 11B. FIG. 12A is an enlarged view illustrating a part of the liquid discharge portion. FIG. 12B is a cross-section diagram of the liquid discharge portion taken along an A-A line illustrated in FIG. 12A.

The liquid discharge head according to the present exemplary embodiment is a circulation type head, and includes the recording element substrate 1101 illustrated in FIGS. 11A, 11B, 12A, and 12B. The liquid discharge head according to the present exemplary embodiment is basically configured of the same components as those in the first exemplary embodiment, except in that the liquid discharge head according to the present exemplary embodiment is configured to circulate the liquid. The recording element substrate 1101 is provided with a plurality of liquid supply paths 40a and a plurality of liquid collection paths 40b, for circulating the liquid. The plurality of discharge ports 10 is arranged in the Y direction at predetermined intervals. On one side of the row of the discharge ports 10 in the X direction, the plurality of liquid supply paths 40a is arranged in the Y direction at predetermined intervals. On the other side thereof in the X direction, the plurality of the liquid collection paths 40b is arranged in the Y direction at predetermined intervals. Each of the discharge ports 10, each of the liquid supply paths 40a, and each of the liquid collection paths 40b communicate with the flow path 60.

The pressure chamber 80 is provided for each of the discharge ports 10. Each of the pressure chambers 80 is partitioned by the flow path walls 50, and is provided with an opening serving as an inlet port on the liquid supply path 40a side, and is provided with an opening serving as an outlet port on the liquid collection path 40b side. The filter members 20 is disposed in the vicinities of the inlet port and the outlet port of the pressure chamber 80. At a time of the liquid discharge operation of the liquid discharge head, the liquid is supplied from the liquid supply path 40a to the pressure chamber 80, and then not-discharged liquid flows from the pressure chamber 80 to the liquid collection path 40b. On the other hand, at a time of the suction recovery operation of suctioning the liquid via the discharge port 10, the liquid is supplied from both of the liquid supply path 40a and the liquid collection path 40b to the pressure chamber 80, and discharged via the discharge port 10. From among the foreign matters that have entered the flow path 60, foreign matters larger than the gap between the filter member 20 and the flow path wall 50 are caught by the filter members 20.

The discharge hole 70 is provided in each of the area 3a facing the liquid supply path 40a of the flow path forming member 2 and the area 3b facing the liquid collection path 40b of the flow path forming member 2. In the present exemplary embodiment, one discharge hole 70 is provided for one liquid supply path 40a, and one different discharge hole 71 is provided for one liquid collection path 40b, but it is not limited thereto. Two or more discharge holes 70 can be provided for one liquid supply path 40a. Similarly, two or more discharge holes 71 can be provided for one liquid collection path 40b. It is desirable that the numbers and positions of the discharge holes 70 and 71 are appropriately set so as to efficiently discharge foreign matters.

With the liquid discharge head according to the present exemplary embodiment, the foreign matters that have entered the flow path 60 from the liquid supply path 40a and the liquid collection path 40b are discharged by suctioning the liquid via the discharge holes 70 and 71. The foreign matters enter the flow path 60 from both of the liquid supply path 40a and the liquid collection path 40b. Thus, as the distance from the liquid supply path 40a to the discharge hole 70 is shorter, the time to be used for discharging the foreign matters via the discharge hole 70 can be shorter, and the discharge amount of the liquid along with the discharge of the foreign matters can be reduced. Similarly, as the distance from the liquid collection path 40b to the discharge hole 71 is shorter, the time to be used for discharging the foreign matters via the discharge hole 71 can be shorter, and the discharge amount of the liquid along with the discharge of the foreign matters can be reduced. In the present exemplary embodiment, the discharge hole 70 is disposed in the area 3a facing the liquid supply path 40a, and the discharge hole 71 is disposed in the area 3b facing the liquid collection path 40b, so that the foreign matters can be discharged in a short time, and the amount of the discharged liquid along with the discharge of the foreign matters can be reduced.

The center of the discharge hole 70 facing the liquid supply path 40a is desirably located on the center of the liquid supply path 40a when viewed from the Z direction. Similarly, the center of the discharge hole 71 facing the liquid collection path 40b is desirably located on the center of the liquid collection path 40b when viewed from the Z direction. In this way, it is possible to further reduce the time to be used for discharging the foreign matters, and further reduce the discharge amount of the liquid along with the discharge of the foreign matters.

In the liquid discharge head according to the present exemplary embodiment, the maximum size of the diameter of each of the discharge holes 70 and 71 is desirably twice the diameter of the discharge port 10, and the minimum size of the discharge hole 70 is desirably one third of the diameter of the discharge port 10, from the same reason described in the first exemplary embodiment. In the present exemplary embodiment, the size of the diameter of the discharge port 10 is set to, for example, 15 μm, and each of the diameters of discharge holes 70 and 71 are set to, for example, 18 μm, similarly to the first exemplary embodiment.

Next, a suction recovery method of the liquid discharge head according to the present exemplary embodiment will be described. In a similar manner to the first exemplary embodiment, the suction recovery method includes the first suction recovery operation of suctioning the liquid via the discharge holes 70 and 71 and discharging the foreign matters, and the second suction recovery operation (typical suction recovery operation) of suctioning the liquid via the discharge ports 10 and filling the liquid in the entire flow path 60.

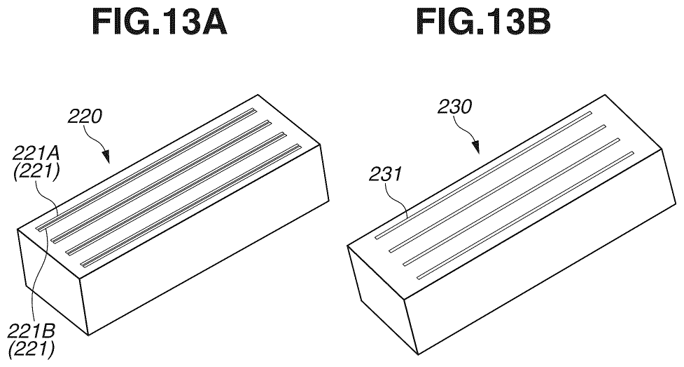

FIGS. 13A and 13B are schematic diagrams each illustrating a configuration of a cap for performing suction recovery. FIG. 13A illustrates a cap to be used for the first suction recovery operation, and FIG. 13B illustrates a cap to be used for the second suction recovery operation.

First, the first suction recovery operation will be described.

A cap 220 illustrated in FIG. 13A is attached to the recording element substrate 1101 illustrated in FIG. 11A. The cap 220 is provided with suction holes 221 (221A and 221B) for the respective rows of the discharge holes 70 and 71. In the present exemplary embodiment, in the recording element substrate 1101, two discharge hole rows including a row of the discharge holes 70 and a row of the discharge holes 71 are disposed for a row of the discharge ports 10. The suction hole 221A is provided for the row of the discharge holes 70 on one side, and the suction hole 221B is provided for the row of the discharge holes 71 on the other side. The suction holes 221A and 221B can each have, for example, an elongated slit shape. Since the recording element substrate 1101 is provided with four rows of the discharge ports 10, the cap 200 is provided with four suction holes 221A and four suction holes 221B.

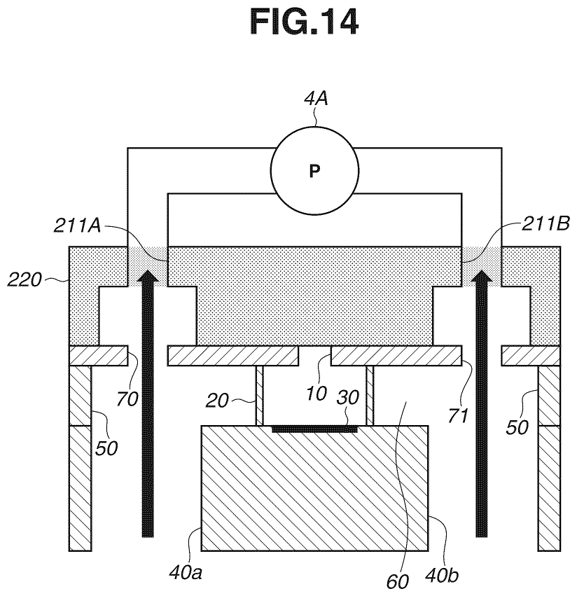

FIG. 14 is a cross-section diagram illustrating a cross-section structure of a part of the recording element substrate 1101 with the cap 220 attached thereto. In FIG. 14, the cross-section part of the recording element substrate 1101 is similar to that illustrated in FIG. 12B. Black solid arrows illustrated in FIG. 14 denote flows of liquid.

As illustrated in FIG. 14, the discharge hole 70 facing the liquid supply path 40a communicates with the suction hole 211A of the cap 220, and the discharge hole 71 facing the liquid collection path 40b communicates with the suction hole 211B of the cap 220. The discharge port 10 disposed between the suction hole 211A and the suction hole 211B is covered by the cap 220. In this state, when the liquid is suctioned via the suction holes 211A and 211B using the pump 4A, the liquid flows from both of the liquid supply path 40a and the liquid collection path 40b to the flow path 60, and then is discharged via the suction holes 211A and 211B after passing through the discharge holes 70 and 71

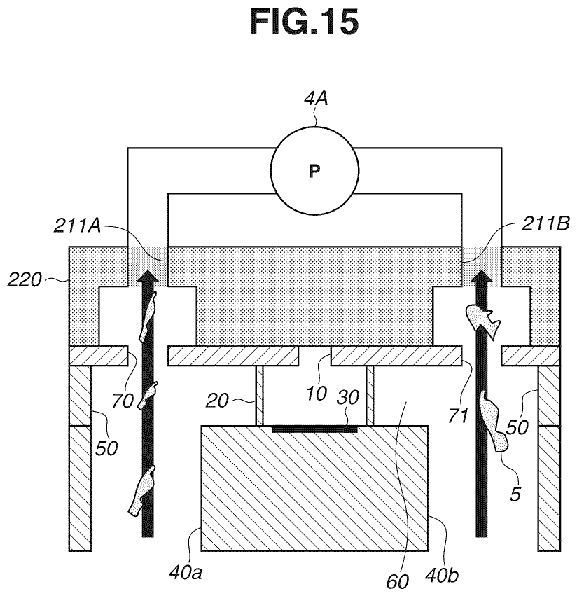

FIG. 15 is a schematic diagram illustrating a state where foreign matters 5 are discharged via the discharge holes 70 and 71, in the cross-section diagram illustrated in FIG. 14. Black solid arrows illustrated in FIG. 15 denote flows of liquid. As illustrated in FIG. 15, by the suction operation using the pump 4A, the foreign matters 5 enter the flow path 60 from both of the liquid supply path 40a and the liquid collection path 40b, and then are discharged through the discharge holes 70 and 71. Foreign matters 5 having a size larger than the diameters of the discharge holes 70 and 71 clog the discharge holes 70 and 71, or remain in the flow path 60. The foreign matters 5 having a large size remaining in the flow path 60 can be caught by the filter members 20.

The second suction recovery operation will now be described.

A cap 230 illustrated in FIG. 13B is attached to the recording element substrate 1101 illustrated in FIG. 11A. The cap 230 is provided with a suction hole 231 for every row of the discharge ports 10.

The suction hole 231 can have, for example, an elongated slit shape. In the present exemplary embodiment, the recording element substrate 1101 is provided with four rows of the discharge ports 10, thus the cap 230 is provided with four suction holes 231. However, the number of rows of the suction holes 231 is not limited to four. The number of the suction holes 231 can be appropriately changed depending on the number of rows of the discharge ports 10.

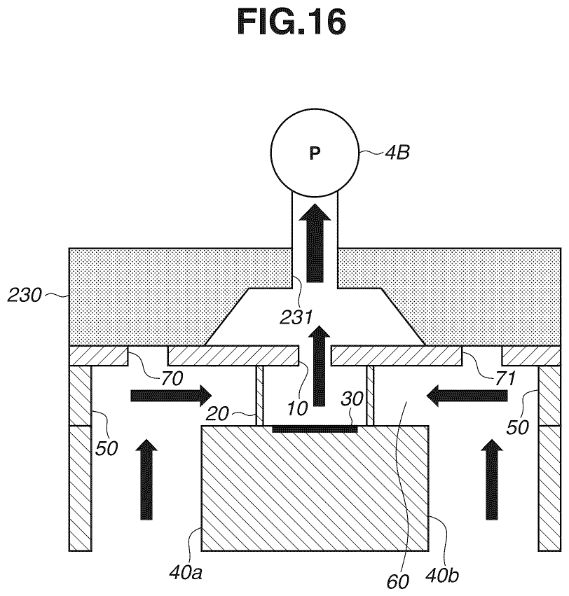

FIG. 16 is a cross-section diagram illustrating a cross-section structure of a part of the recording element substrate 1101 with the cap 230 attached thereto. In FIG. 16, the cross-section part of the recording element substrate 1101 is similar to that illustrated in FIG. 12B. Black solid arrows illustrated in FIG. 16 denote flows of liquid.

As illustrated in FIG. 16, the discharge holes 70 and 71 are covered by the cap 230, and the discharge port 10 communicates with the suction hole 231 of the cap 230. In this state, when the liquid is suctioned via the suction hole 231 by the pump 4B, the liquid flows into the flow path 60 from both of the liquid supply path 40a and the liquid collection path 40b, and then is discharged via the discharge port 10 and the suction hole 231.

In this way, the liquid can be filled in the entire flow path 60. The pump 4A and the pump 4B can be one common pump.

Next, a liquid discharge head not including the discharge holes 70 and 71 according to a second comparison example will be described how discharge defects caused by the clogging of discharge ports occur.

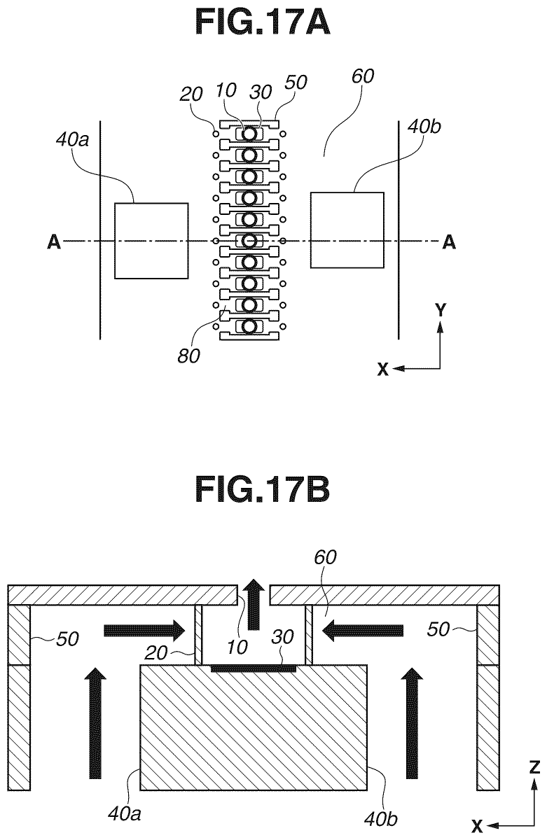

FIGS. 17A and 17B are diagrams illustrating a configuration of a liquid discharge head according to the second comparison example. FIG. 17A is an enlarged view illustrating a part of a liquid discharge portion. FIG. 17B is a cross-section diagram illustrating the liquid discharge portion taken along an A-A line illustrated in FIG. 17A. The liquid discharge head according to the second comparison example illustrated in FIGS. 17A and 17B has similar configuration to that of the liquid discharge portion illustrated in FIG. 12, except in that the liquid discharge head according to the second comparison example does not have the discharge holes 70 and 71. Black solid arrows illustrated in FIG. 17B denote flows of liquid.

The liquid discharge head according to the second comparison example performs the suction recovery operation of suctioning the liquid via the discharge ports 10 to fill the liquid in the entire flow path 60, in a manufacturing process and an assembling process and at a time of a liquid tank exchange. As illustrated in FIG. 17B, the liquid flows into the flow path 60 from both of the liquid supply path 40a and the liquid collection path 40b through the suction recovery operation, and then the liquid is discharged via the discharge port 10. In this way, the liquid can be filled in the entire flow path 60.

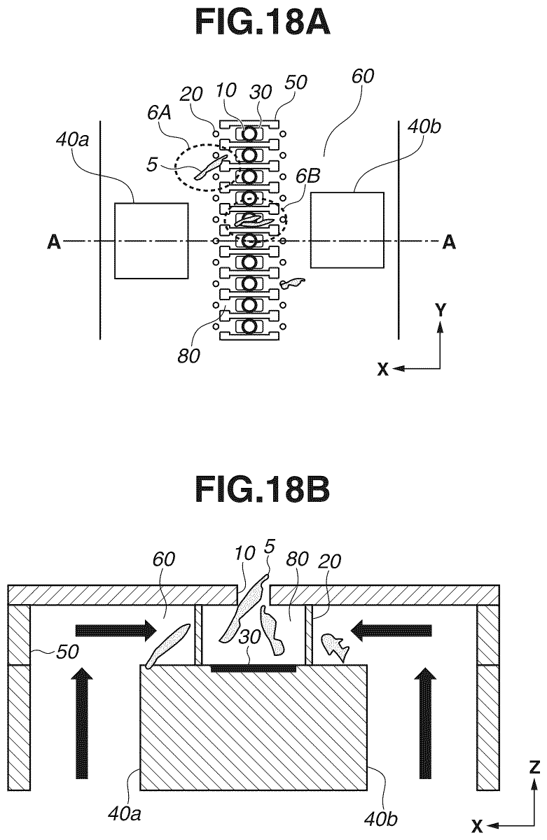

FIGS. 18A and 18B are schematic diagrams illustrating a state where the foreign matters 5 illustrated in FIGS. 17A and 17B move. FIG. 18A corresponds to FIG. 17A, and FIG. 18B corresponds to FIG. 17B. As illustrated in FIGS. 18A and 18B, when the suction recovery operation is performed, the foreign matters 5 enter the flow path 60 from both of the liquid supply path 40a and the liquid collection path 40b, and the foreign matters 5 having passed through the filter members 20 move toward the discharge port 10. In the area 6A outside the pressure chamber 80, the discharge defect does not occur in a state where the foreign matters 5 are caught by the filter member 20. However, in the area 6B inside the pressure chamber 80, clogging of the discharge port 10 caused by the foreign matters 5 occurs, and a discharge defect occurs.

The liquid discharge head according to the present exemplary embodiment performs the second suction recovery operation after removing the foreign matters through the first suction recovery operation to fill the liquid in the entire flow path 60, in a manufacturing process and an assembling process and at a time of a liquid tank replacement. With this operation, it is possible to prevent the discharge defect caused by the clogging of the discharge port 10, and as a result, to improve the yield and the print quality.

For a similar reason as in the first exemplary embodiment, the liquid discharge head according to the present exemplary embodiment can also suppress an increase in the size of the recording element substrate 1101 due to the formation of the discharge holes 70 and 71.

In the liquid discharge head according to the present exemplary embodiment, only one of the discharge holes 70 and 71 can be disposed for the liquid supply path 40a and the liquid collection path 40b. The diameter of the discharge hole 70 disposed for the liquid supply path 40a can also be different from the diameter of the discharge hole 71 disposed for the liquid collection path 40b. For example, the diameter of the discharge hole 70 disposed for the liquid supply path 40a can be made larger than the diameter of the discharge port 10, and the diameter of the discharge hole 71 disposed for the liquid collection path 40b can be made larger than the diameter of the discharge port 10. In this case, foreign matters are intentionally made, for example, in a manufacturing process, to clog the discharge hole 71 of the liquid collection path 40b side by performing the first suction recovery operation. When the liquid tank is replaced, the foreign matters are discharged via the discharge hole 70 of the liquid supply path 40a side, by performing the first suction recovery operation. In this way, it is possible to reduce the discharge amount of the liquid along with the discharge of the foreign matters.

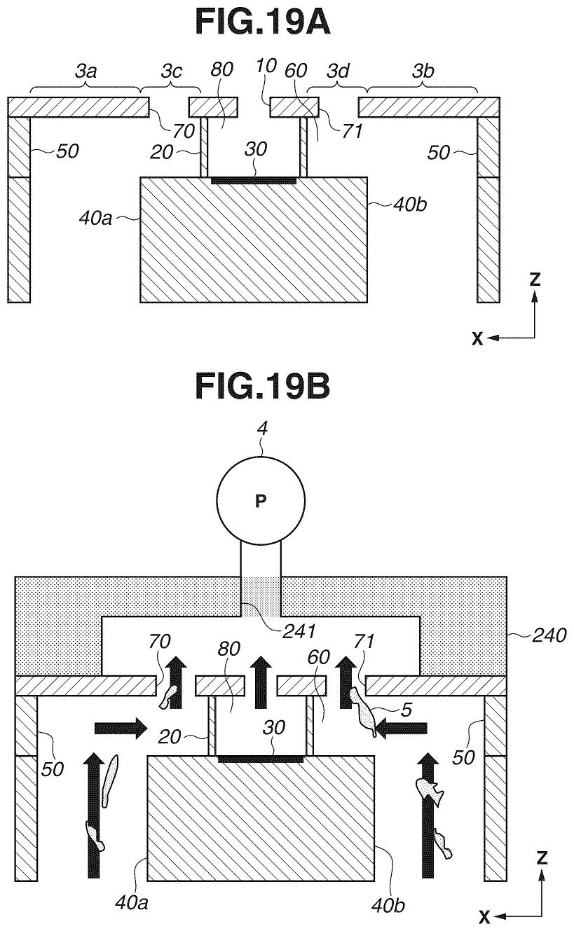

FIGS. 19A and 19B are schematic diagrams illustrating a configuration of a liquid discharge head according to a third exemplary embodiment of the present disclosure. FIG. 19A is a cross-section diagram illustrating a part of the recording element substrate 1101. FIG. 19B is a cross-section diagram illustrating the part of the recording element substrate 1101 with a cap 240 attached thereto. In FIG. 19B, the cross-section part of the recording element substrate 1101 is similar to that illustrated in FIG. 19A. Black solid arrows illustrated in FIG. 19 denote flows of liquid.

A liquid discharge head according to the present exemplary embodiment has a configuration similar to that according to the second exemplary embodiment, except in that the discharge holes 70 and 71 are disposed near the discharge port 10. The same symbols are assigned to the same configurations, and detailed descriptions thereof are omitted here.

As illustrated in FIG. 19A, the discharge hole 70 is provided in an area 3c adjacent to the discharge hole 70 side of an area 3a facing the liquid supply path 40a. In the flow path 60, the discharge hole 70 is provided between the liquid supply path 40a and the plurality of discharge ports 10, more specifically, between the liquid supply path 40a and the plurality of filter members 20. The different discharge hole 71 is provided in an area 3d adjacent to the discharge hole 71 side of an area 3b facing the liquid collection path 40b. In the flow path 60, the different discharge hole 71 is disposed between the liquid collection path 40b and the plurality of discharge ports 10, more specifically, between the liquid collection path 40b and the plurality of filter members 20.

The liquid discharge head according to the present exemplary embodiment performs the suction recovery using the cap 240 illustrated in FIG. 19B. The cap 240 includes suction holes 241. In a state where the cap 240 is attached to the liquid discharge head, the suction hole 241 communicates with the discharge port 10, and the discharge holes 70 and 71 located on both opposite sides of the discharge port 10. In this state, when the liquid is suctioned via the suction hole 241 using a pump 4, the liquid flows into the flow path 60 from both of the liquid supply path 40a and the liquid collection path 40b. The liquid flowed in the flow path 60 is discharged via the suction hole 241 after passing through the discharge holes 70 and 71, and is also discharged via the suction hole 241 after passing through the filter members 20 and the discharge ports 10. The foreign matters 5 enter the flow path 60 from both of the liquid supply path 40a and the liquid collection path 40b, and then are discharged via the discharge holes 70 and 71. Foreign matters 5 having a size larger than the diameters of the discharge holes 70 and 71 clogs the discharge hole 70 or 71, or remains in the flow path 60. The foreign matters 5 having a large size remaining in the flow path 60 can be caught by the filter members 20.

The liquid discharge head according to the present exemplary embodiment can simultaneously perform, in addition to the effects described in the first and second exemplary embodiments, the filling of the liquid in the flow path 60 and the discharge of the foreign matters 5 with one time of suction recovery operation.

In the flow path 60, the discharge holes 70 are disposed between the liquid supply path 40a and the plurality of discharge ports 10, and the discharge holes 71 are disposed between the liquid collection path 40b and the plurality of discharge ports 10.

With this configuration, a space for disposing the discharge holes 70 and 71 does not need to be separately secured. Similarly to the first and second exemplary embodiment, the liquid discharge head according to the present exemplary embodiment can also suppress an increase in the size of the recording element substrate 1101 due to the formation of the discharge holes 70 and 71.

The liquid discharge heads according to the first and second exemplary embodiments can also fill the liquid in the flow path 60 and discharge the foreign matters 5 simultaneously with one suction recovery operation. The liquid discharge head according to the first exemplary embodiment has a configuration where, for example, the suction hole 201 of the cap 200 illustrated in FIG. 6 communicates with the discharge hole 70 and the discharge port 10 respectively located on the opposite sides of the discharge hole 70. In this way, it becomes possible to fill the liquid in the flow path 60 and to discharge the foreign matters 5 simultaneously. The liquid discharge head according to the second exemplary embodiment also has a configuration where, for example, the suction hole 231 of the cap 230 illustrated in FIG. 16 communicates with the discharge port 10 and the discharge holes 70 and 71 respectively located on both opposite sides of the discharge port 10. In this way, it becomes possible to fill the liquid in the flow path 60 and to discharge the foreign matters 5 simultaneously.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-063128, filed Apr. 10, 2024, which is hereby incorporated by reference herein in its entirety.

What is claimed is:

1. A liquid discharge head, comprising:
a substrate including at least one liquid supply path for supplying liquid;
a flow path forming member including a plurality of discharge ports for discharging the liquid, joined with the substrate, and configured to form a flow path communicating with the plurality of discharge ports and the at least one liquid supply path; and
at least one discharge hole for discharging the liquid, provided in an area facing the at least one liquid supply path of the flow path forming member to penetrate through the flow path forming member.

2. The liquid discharge head according to claim 1, wherein a diameter of the at least one discharge hole is equal to or less than twice of a diameter of each of the plurality of discharge ports.

3. The liquid discharge head according to claim 1, wherein a diameter of the at least one discharge hole is equal to or greater than one third of a diameter of each of the plurality of discharge ports.

4. The liquid discharge head according to claim 1, wherein the at least one discharge hole faces the at least one liquid supply path.

5. The liquid discharge head according to claim 4,
wherein the plurality of discharge ports is arranged in a first direction,
wherein the at least one liquid supply path extends in the first direction, and
wherein a center of the at least one discharge hole is located on a center in a width direction of the at least one liquid supply path.

6. The liquid discharge head according to claim 1,
wherein the plurality of discharge ports includes a first discharge port row and a second discharge port row in each of which discharge ports are arranged in a first direction,
wherein the at least one discharge hole includes a discharge hole row in which a plurality of discharge holes is arranged in the first direction, and
wherein the discharge hole row is arranged at an intermediate position between the first discharge port row and the second discharge port row in a second direction orthogonal to the first direction.

7. The liquid discharge head according to claim 1,
wherein the substrate includes at least one liquid collection path communicating with the flow path to collect the liquid, and
wherein the substrate includes at least one different discharge hole different from the at least one discharge hole for discharging the liquid, provided in an area facing the at least one liquid collection path of the flow path forming member or adjacent to a discharge port side of the area to penetrate through the flow path forming member.

8. The liquid discharge head according to claim 7, wherein a diameter of the at least one different discharge hole is equal to or less than twice of a diameter of each of the plurality of discharge ports.

9. The liquid discharge head according to claim 7, wherein a diameter of the at least one different discharge hole is equal to or greater than one third of a diameter of each of the plurality of discharge ports.

10. The liquid discharge head according to claim 7, wherein the at least one different discharge hole faces the at least one liquid recovery path.

11. The liquid discharge head according to claim 10,
wherein the plurality of discharge ports is arranged in a first direction,
wherein the at least one liquid collection path extends in the first direction, and
wherein a center of the at least one different discharge hole is located on a center in a width direction of the at least one liquid collection path.

12. The liquid discharge head according to claim 7, wherein a diameter of the at least one discharge hole is different from a diameter of the at least one different discharge hole.

13. A liquid discharge head, comprising:
a substrate including at least one liquid supply path for supplying liquid;
a flow path forming member including a plurality of discharge ports for discharging the liquid, joined with the substrate, and configured to form a flow path communicating with the plurality of the discharge ports and the at least one liquid supply path; and
at least one discharge hole for discharging the liquid, provided in an area adjacent to a discharge port side of an area facing the at least one liquid supply path of the flow path forming member to penetrate through the flow path forming member.

14. A liquid discharge head, comprising:
a discharge port row in which a plurality of discharge ports for discharging liquid is arranged;
at least one discharge hole for discharging the liquid, arranged on a lateral side of the discharge port row;
a flow path configured to communicate with each of the plurality of discharge ports in the discharge port row, and the at least one discharge hole; and
a plurality of energy generation elements configured to generate a discharge energy to discharge the liquid,
wherein the plurality of energy generation elements faces only the plurality of discharge ports in a discharge direction of the liquid.
